(19) United States
(12) Patent Application Publication
(10) Pub. No.: US 2007/0010185 A1
(43) Pub. Date: Jan. 11, 2007

(54) Coin handling apparatus having slidably displaceable housing parts

(76) Inventors: Jerry Karlsson, Lund (SE); Anders Sjostrom, Lund (SE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/440,544

(22) Filed: May 25, 2006

Related U.S. Application Data
(63) Continuation of application No. PCT/SE04/01749, filed on Nov. 29, 2004.

(30) Foreign Application Priority Data
Dec. 2, 2003 (SE) 0303252-3

(51) Int. Cl. G07D 3/00

(52) U.S. Cl. 453/3

(57) ABSTRACT

A coin handling apparatus has an apparatus housing and a coin processing device contained within said apparatus housing, wherein said apparatus housing has a coin intake, said coin handling apparatus being adapted to receive coins to be processed by said coin processing device through said coin intake from a user. The apparatus housing comprises a first housing part and a second housing part, wherein said coin intake is provided in said second housing part and wherein said second housing part is displaceable from said first housing part so as to expose said coin processing device to said user.

### CROSS-REFERENCE TO RELATED APPLICATIONS

This application is a continuation of international application no. PCT/SE04/001749, filed on Nov. 29, 2004, and designating the United States of America; which application claims the benefit of Swedish patent application no. 0303252-1, filed on Dec. 2, 2003 and U.S. provisional patent application No. 60/527,814, filed on Dec. 8, 2003.

### INCORPORATION BY REFERENCE

The specifications and drawings of PCT/SE04/001749, filed on Nov. 29, 2004; Swedish patent application no. 0303252-1, filed on Dec. 2, 2003 and U.S. provisional patent application No. 60/527,814, filed on Dec. 8, 2003 are incorporated herein in their entirety, by this reference.

### TECHNICAL FIELD

The present invention relates to coin handling, and more particularly to a coin handling apparatus comprising an apparatus housing and a coin processing device contained within the apparatus housing, wherein the apparatus housing has a coin intake and the coin handling apparatus is adapted to receive coins to be processed by the coin processing device through the coin intake from a user.

### BACKGROUND ART

A coin sorter or coin counter that employs active or passive coin separating technology is an example of an apparatus according to the above. Active coin separating technology means that each coin separating station has a controllable movable member, which in response to control signals may be switched between an activated position, in which the controllable member interferes with the transport path and will cause a valid coin to be separated off the transport path, and an inactivated position, in which the controllable member is retracted from the transport path and will admit the coin to continue along the transport path past the coin separating station. Commonly, the coin separating stations are implemented as electromagnetic solenoids with movable cores, to which the controllable members are pivotally coupled. Which coin separating station to activate for a certain coin is determined by a coin sensor and a controller, which will detect physical characteristics such as conductivity, permeability, thickness and/or diameter of the coin and in response generate control signals having appropriate voltage or current levels and supply these control signals to the coin separating stations in a timely manner so as to cause activation of the correct station at the correct time (i.e., just before the coin reaches the station in question), without inadvertently separating off any other adjacent coin than the intended one. One example of a coin sorter with active coin separating technology is disclosed in WO 99/33030.

Other types of coin sorters and coin counters instead use passive coin separating technology. Here, instead of using controllable coin separating stations, the coins are separated by means of a purely passive arrangement. For instance, an inclined coin rail may be used, along which the coins will roll down and be knocked off the coin rail by a series of separating knives which are arranged at successively decreasing heights above the coin rail, thereby first separating coins with the largest diameter, then coins having the second largest diameter, etc. Another common type of passive coin separating technology instead uses a rotary feeder, which transports the coins in a circular transport path across a base plate, in which coin openings of successively increasing size are arranged.

For maximum user convenience, many coin handling apparatuses are top-loaded, i.e. they have a coin intake provided at a top side surface of the apparatus housing. This allows an ergonomic work position for a user when depositing e.g. a box, can or bag of coins into the apparatus, to be sorted and/or counted by the apparatus in a coin processing transaction. It also allows the user to visually inspect the mass of coins thus deposited before starting the coin processing transaction, thereby allowing the user to identify foreign objects that are not to be included in the coin processing transaction.

A coin handling apparatus will be subjected to malfunction from time to time, irrespective of whether its coin processing device is based on active or passive coin separating technology. For instance, coins or accidental foreign objects may cause a coin jam situation which will stop the flow of coins in a coin processing transaction until the malfunction is remedied. In order to remedy the malfunction, or in order to give periodic maintenance to the apparatus, the user or a service person will normally have to get access to the internal coin processing device, which is otherwise encapsulated within the apparatus housing. When a malfunction occurs, there may be received coins that still have not left a coin input region at or close to the coin intake. More specifically, such coins may represent a substantial weight, and if the coins are still at the coin input region, they may be in the way for the user or service person when the internal coin processing device is to be accessed through the apparatus housing. In some prior art coin handling apparatuses, the apparatus housing comprises a top lid or hood, which is pivotally mounted to the main part of the apparatus housing. If the coin input region with the coin intake is provided in the lid or hood in a top-loaded manner, the user or service person may have to lift a considerable weight when opening the lid or hood with a pivotal move, this weight being constituted by the sum of the weight of the lid or hood itself, the weight of any coin receiving device provided at the coin input region (such as an input tray, etc.) and the weight of any remaining coins within the coin input region.

### SUMMARY OF THE INVENTION

An objective of the present invention is to provide a solution to the problems discussed above. Particularly, an objective is to provide a solution which allows ergonomic and convenient access to the interior of a coin handling apparatus in situations such as periodic maintenance or malfunction remedies.

Generally, the above objectives are achieved by a coin handling apparatus according to claim 1.

One aspect of the invention is a coin handling apparatus comprising an apparatus housing and a coin processing device contained within said apparatus housing, wherein said apparatus housing has a coin intake, said coin handling apparatus being adapted to receive coins to be processed by said coin processing device through said coin intake from a user. The apparatus housing comprises a first housing part and a second housing part, wherein said coin intake is provided in said second housing part and wherein said second housing part is displaceable from said first housing part so as to expose said coin processing device to said user.

Thus, access to the interior of the coin handling apparatus is provided in an ergonomic and convenient manner by allowing the user to displace the second housing part from the first housing part, rather than opening it in a pivotal move. Providing the coin intake in the displaceable housing part, i.e. the second housing part, is advantageous in that it will allow the user to conveniently inspect any coins or other objects that are present in the coin input region and that may be part of the problem, for instance in a coin jam situation. In one particularly advantageous embodiment, the coin intake is therefore provided at a top side surface of the second housing part. In this embodiment, the second housing part is displaceable from the first housing part in a substantially horizontal direction parallel to the top side surface.

One embodiment further comprises a base onto which the coin processing device is mounted, wherein the base remains fixed with respect to the first housing part when the second housing part is displaced from the first housing part.

Means may be provided for supporting slidable displacement of the second housing part with respect to the first housing part. Such means advantageously includes a pair of rails mounted to the base.

In one embodiment the apparatus further has a conveyor belt provided at the coin intake, said conveyor belt being adapted to receive the coins to be processed from the user and to feed the received coins to the coin processing device. In addition, a coin input trapdoor may preferably be provided at the coin intake, the trapdoor being controllable to assume first and second positions, wherein, in the first position, the received coins are prevented from entering the coin processing device and wherein, in the second position, the received coins are permitted to enter the coin processing device. Furthermore, a controller in the apparatus may be adapted, in response to a detected malfunction of the apparatus, to cause the trapdoor to assume its first position, thereby preventing any received coins from being fed to the coin processing device and possibly worsening the malfunction situation.

One such malfunction situation may be when the second housing part is unexpectedly displaced from the first housing part, for instance by the user, during an ongoing coin processing transaction.

In one embodiment the apparatus further has a controller and a coin sensor, the coin sensor being adapted to detect at least one physical characteristic, such as conductivity, permeability, thickness and/or diameter, in the presence of a coin, wherein said controller is adapted, during an ongoing coin processing transaction, to cause said trapdoor to assume its first position so as to prevent input of coins from said coin intake to said coin processing device; cause said coin sensor to produce a calibration value related to said at least one physical characteristic in the absence of coins; and cause said trapdoor to assume its second position so as to admit input of coins from said coin intake to said coin processing device.

Thus, the provision of a trapdoor at the coin intake allows coin sensor calibration also during an ongoing coin processing transaction by temporarily suspending the feeding of coins to the coin processing device by closing the trapdoor, obtaining the desired calibration readings from the coin sensor and then resuming the feeding of coins and the coin processing transaction by opening the trapdoor.

In embodiments that have a conveyor belt in addition to a trapdoor and a controller, the controller may be adapted, when causing said trapdoor to assume its first position, to also cause said conveyor belt to stop feeding received coins.

The coin processing device may employ active or passive coin separating technology, having e.g. a circular or linear coin transport path. In one embodiment, the coin processing device operates by active, circular coin separation and thus comprises a plurality of coin separating stations and a coin sensor positioned along a circular transport path defining a coin transport direction, each coin separating station comprising a controllable member for separating coins individually off said circular transport path in response to at least one coin characteristic detected by said coin sensor, wherein said coin separating stations include at least one station assigned for separation of valid coins, as indicated by said at least one coin characteristic.

As referred to herein, the term “coin” includes coins that form part of a monetary system for a particular currency, as well as similar objects such as non-monetary coins, markers and tokens.

Other objectives, features and advantages of the present invention will appear from the following detailed disclosure, from the attached dependent claims as well as from the drawings.

### BRIEF DESCRIPTION OF THE DRAWINGS

An exemplifying embodiment of a coin handling apparatus according to the invention will now be described in detail with reference to the accompanying drawings, in which:

FIG. 1 is a perspective view of the coin handling apparatus in its normal operating position, where the apparatus housing is closed,

FIG. 2 is a perspective view of the coin handling apparatus of FIG. 1, with a front part of the apparatus housing withdrawn like a drawer from a rear part of the apparatus housing, wherein an internal coin processing device is revealed,

FIG. 3 is a plan view of the rear part of the apparatus housing and the coin processing device of FIG. 2,

FIG. 4 is a perspective and partly sectional view of the coin handling apparatus, illustrating portions of the coin processing device, wherein input of coins to the coin processing device is prevented by a coin input trapdoor assuming a closed position,

FIG. 5 is a view corresponding to the one shown in FIG. 4, however with the coin input trapdoor in an open position which permits reception of coins in the coin processing device,

FIG. 6a is a view similar to the one shown in FIG. 4, and

FIG. 6b is an enlarged perspective sectional view of one area in the coin processing device.

### DETAILED DISCLOSURE OF AN EXEMPLIFYING EMBODIMENT

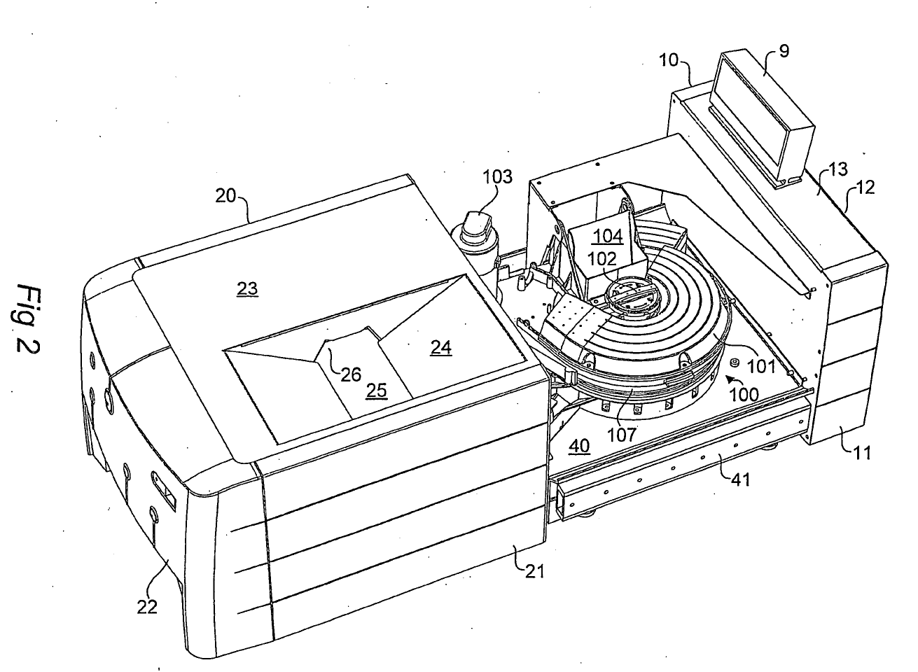

The coin handling apparatus 1 has an apparatus housing or cabinet 2, which comprises a withdrawable front part 20 and a rear part 10, the latter of which also comprises a base 40 for a coin processing device 100. The front part 20 of the apparatus housing 2 is slidably supported by rails 41 (only one of which is shown in FIG. 2) and may thus be withdrawn by a user from the rear part 10 in a convenient manner so as to provide access to the coin processing device 100 and other internal components of the coin handling apparatus 1, for instance when a malfunction is to be remedied by the user.

The rear part 10 of the apparatus housing 2 has a top side 13, lateral sides 111 as well as a back side 12. The top side 13 has a display 9, which advantageously may be removably attached to the apparatus housing 2, thereby allowing the user to instead place the display at a position external to the coin handling apparatus 1. The back side 12 has a plurality of terminals and connectors 14-19, one of which may be a display port for connecting the display 9 to the electronic control circuitry of the coin handling apparatus 1 (a controller 130 included in said electronic control circuit being shown in the drawings). The connectors and terminals 14-19 also include a mains power connection as well as a computer communication interface. The computer communication interface may be a serial interface such as RS232 or USB, a network interface such as Ethernet Twisted Pair (RJ45), or a wireless interface such as Bluetooth. By means of the computer communication interface, the coin handling apparatus 1 may be connected to an external local or remote computer so as to report a result of a completed coin processing transaction to the computer. The computer communication interface may also be used for reporting operational data such as error rates, coin denomination statistics, etc, to the computer. Additionally, the computer communication interface may be used for downloading software and/or settings data to the electronic control circuitry of the coin processing apparatus 1.

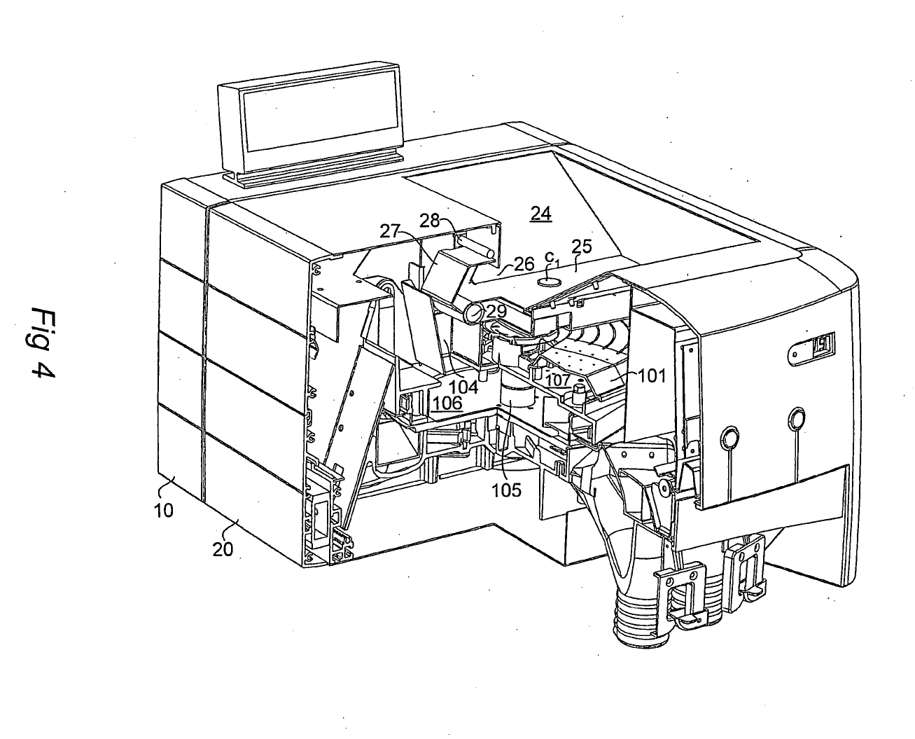

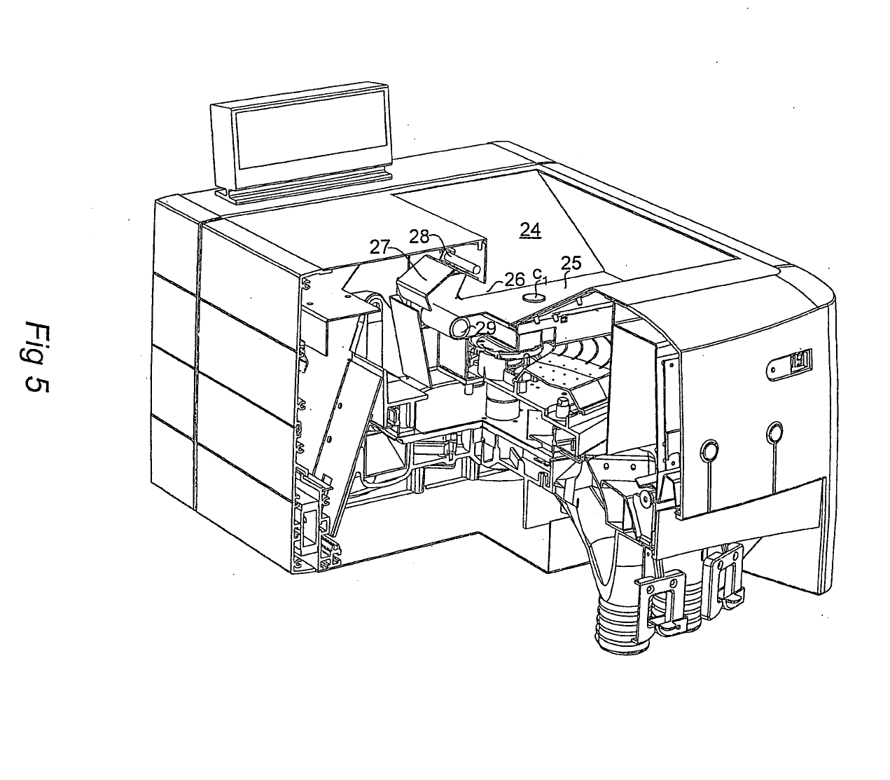

The front part 20 of the apparatus housing 2 has a top side 23, lateral sides 21 and a front side 22. A coin intake 24 or coin input region is formed in the top side 23. At the bottom of the coin intake 24 a conveyor belt 25 is provided for transporting received coins c, (FIG. 4) to the interior of the coin handling apparatus 1 through a coin input opening 26. A coin input trapdoor 27 is provided at the coin input opening 26 and is hinged to an actuator 28, by means of which the coin input trapdoor 27 may assume a first, closed position, which is shown in FIG. 4 and in which the received coins c₁ are prevented from entering the interior of the coin handling apparatus 1, and a second, open position, which is shown in FIG. 5 and which permits the received coins c₁ to enter the interior of the coin handling apparatus 1. In more detail, as seen in FIGS. 4 and 5, an angled end portion of the coin input trapdoor 27 will abut against the conveyor belt 25 at one of its drive pulleys 29 in the closed position. In the open position, the actuator 28 will pivot the coin input trapdoor 27 and its angled end away from the conveyor belt 25, as seen in FIG. 5. In this position, the received coins c₁ will pass the coin input opening 26, exit the conveyor belt 25 after having passed the drive pulley 29 and fall down through a coin input channel 104 so as to ultimately land on a rotary disc 106, which is part of the coin processing device 100.

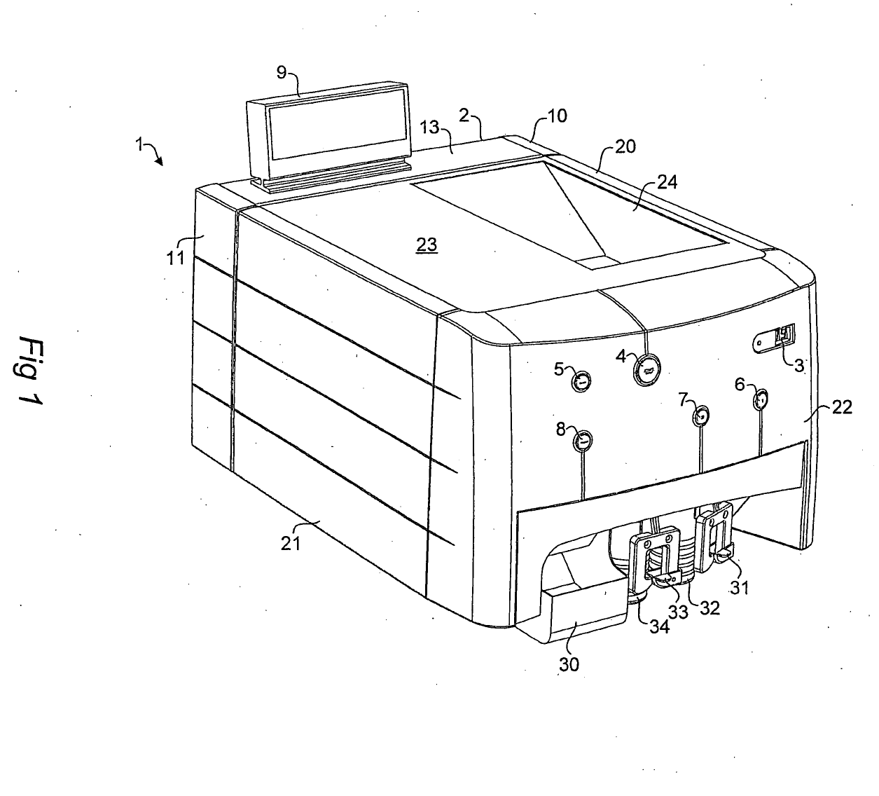

Referring back to FIG. 1, the front side 22 of the front part 21 of the apparatus housing 2 has an LED error indicator 3, a start/stop button 4, a reset button 5, and buttons 6, 7 for selecting between first and second coin bags, in which coins that have been processed by the coin processing device 100 will ultimately be collected through output ducts 32, 34. The coin bags are not shown in FIG. 1, but their attachments are indicated at 31 and 33. In other embodiments, the coin bag buttons 6, 7 may be replaced by visual indicators, which will indicate to the user of the coin handling apparatus 1 which one of the coin bags that is currently used for collecting processed coins, or by combined buttons and indicators. A coin reject indicator 8 is provided adjacently to a receptacle 30 for rejected coins. The reject receptacle 30 is located at an exterior position which is conveniently accessible to the user, and the reject receptacle may further advantageously be removable from the coin handling apparatus 1 so as to facilitate further handling of the coins that have been collected in the reject receptacle 30. The reset button 5 may also be used for commanding transmission of the results of a completed coin processing transaction to an external computer through aforesaid computer communication interface, or for storing the results in an internal memory in the coin handling apparatus 1.

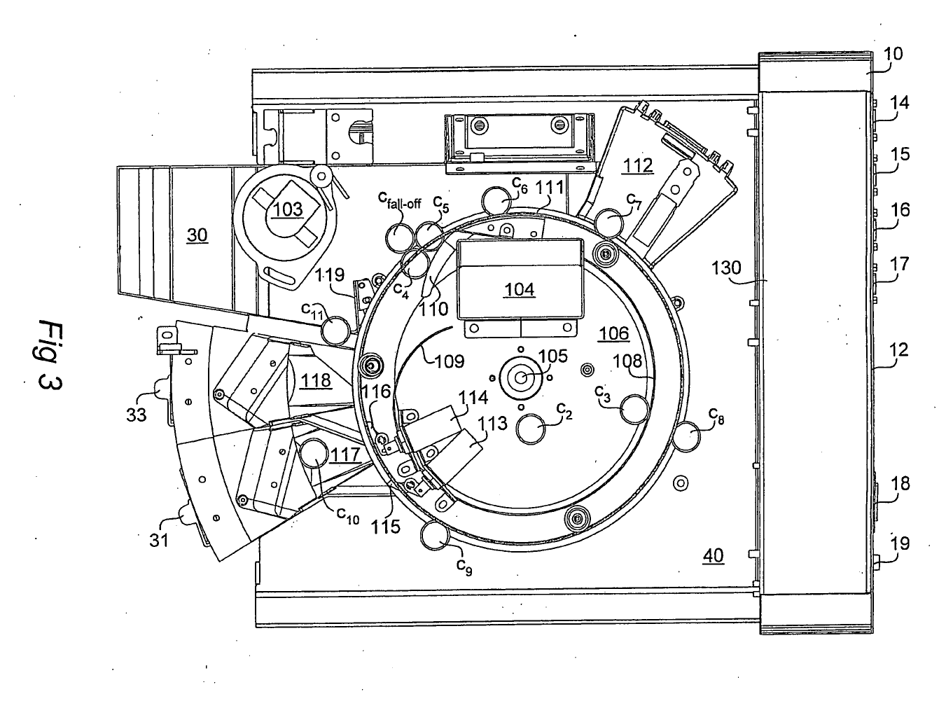

The structure and operation of the coin processing device 100 is generally very similar to that of the coin handling apparatus which is described in aforesaid WO 99/33030, which is fully incorporated herein by reference. Therefore, a lengthy description in greater detail of all the components is not given here; nevertheless, a sufficiently enabling disclosure is given in the following. The coin processing device 100 has a circular coin processing arrangement, which includes two coin separating stations 113, 114 (FIG. 3) arranged along a circular coin transport path 111. The coin transport direction is clockwise in FIG. 3. The number of coin separating stations is considerably less in the exemplifying embodiment of the present invention (i.e., two) than in the embodiment illustrated in aforesaid WO 99/33030 (i.e., ten), the reason being that whereas the apparatus shown in WO 99/33030 is a coin sorter for sorting a plurality of coin denominations, the exemplifying embodiment of the present invention is a coin value counter, which does not act to physically separate different coin denominations into different coin receptacles but merely to identify different coin denominations and calculate an accumulated value for the processed coins. Having two coin separating stations 113, 114 even for a value counting-only coin handling apparatus allows the apparatus to switch between two coin bags when one of the bags has become full of coins, thereby prolonging the operational time between substitution of full coin bags with empty ones. It is to be observed and emphasized that the exact number of coin separating stations is not an essential feature of the present invention.

To accomplish the transport of received coins along the circular transport path 111, the coin processing device 100 has a coin feeding mechanism which comprises a rotary coin feeder 107, which is mounted at its center on an axle 105. An electric motor 103 is coupled to the rotary coin feeder 107 through a drive belt (not shown in the drawings) so as to cause the coin feeder 107 to rotate when the motor 103 is driven. An upper cover 101 protects the coin feeder 107 and the other components of the coin processing device 100 and is secured in position by a lock 102 which is screwed on to the axle 105. By unscrewing the lock 102, the cover 101 may be removed from the coin processing device 100.

When coins c₁ have been received through the coin input channel 104 in the manner described previously, they are received on the surface of the rotary disc 106, as indicated at C₂ in FIG. 3. Upon rotation of the coin feeder 107 by way of the electric motor 103, a resilient rim 111 which is mounted to the lower surface of the feeder 107 comes in frictional engagement with the rotary disc 106, and consequently also the rotary disc 106 will be caused to rotate. As a consequence, the coins on the surface of the rotary disc 106 will be accelerated by centripetal force in a radial direction outwardly and reach a reference edge 108, as seen at C₃ in FIG. 3. The coins will then follow the reference edge 108 and arrive at an end portion 109 of the reference edge 108. In contrast to the preceding portions of the reference edge 108, there is provided an opening between the end portion 109 and the surface of the rotary disc 106, this opening being large enough so as to admit the coins C₃ to slip beneath the end portion 109 and arrive at a position C₄. Here, a deflector knife 110 will push the coins under the resilient rim 111, as seen as C₅, out to a position c₆ in which only a peripheral edge portion of the coins is engaged between the resilient rim 111 and the rotary disc 106. The position referred to as c_{fall-off} is not a normal situation, but it will be referred to in more detail later.

The coins are then transported past a coin sensor or discriminator 112, as seen at C₇ in FIG. 3, where at least one physical characteristic is determined for each coin C₇. Such characteristics may be conductivity, permeability, thickness and/or diameter of the coin C₇. Coin reference data is stored in a memory associated with the controller 130 and serves as a lookup-table that matches different values or value ranges for said coin characteristic(s) to different coin denominations or types. The coin characteristic(s) obtained by the sensor 112 for coin C₇ will be compared to the coin reference data by the controller 130, and in case of a match the denomination of the coin C₇ will be given by said coin reference data, provided that the coin c₂ is a valid coin, as defined by the reference data. Hence, the controller 130 will add the value associated with the denomination of coin C₇ to an accumulated value of all previous coins that have been processed in the current coin processing transaction. The controller 130 will also generate control signals to the appropriate coin separating station 113, 114 so as to actuate a controllable member or deflector 1115, 116 thereof, when the coin has traveled along the circular transport path (position C₈) to a position c₉ near the appropriate coin separating station 113. In the illustrated embodiment, the coin separating stations 113, 114 comprise electromagnetic solenoids, each having a movable core to which the controllable member 115/116 is pivotally coupled.

In FIG. 3, the first coin separating station 1113 is illustrated with its controllable member 115 in its activated position, where the deflector interferes with the resilient rim 111 and will force the coin out of engagement with the resilient rim 111, wherein the coin will fall down into a chute 117 and further down the duct 32 into the coin bag attached to the coin bag attachment 31. Furthermore, the second coin separating station 114 is illustrated in FIG. 3 with its controllable member 116 in its inactivated position, retracted from the resilient rim 111 and thus not causing any passing coin to be pushed off the circular transport path and resilient rim 111.

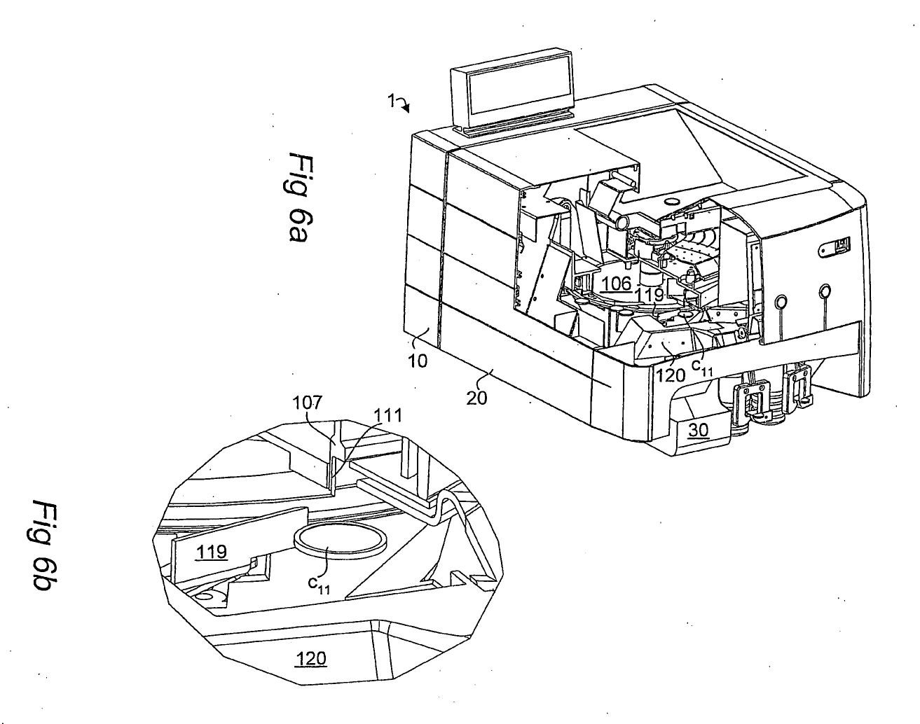

If, in response to the characteristic(s) determined by the sensor 112, the controller 130 decides that a certain coin is not a valid coin, it is handled as a reject coin by the coin processing device 100. In case of a reject coin, both coin separating stations 113, 114 will remain inactivated when the coin passes them, wherein the coin will arrive at a position c₁₁ where it hits a deflector 119 in the form of a knife-shaped metal plate. As seen in FIGS. 3 and 6a/b, the deflector 119 is mounted at a position after the last coin separating station 114 along the circular transport path 111, with one end close enough to the perimeter of the coin feeder 107/rotary disc 106 so as to deflect the coin c₁₁ from the circular transport path into a reject channel 120. After having fallen through the reject channel 120, the coin c₁₁ will be received and collected in the reject receptacle 30. Thus, in contrast to prior-art active, circular coin processing devices, the illustrated embodiment uses a stationary mechanical deflector 119 to deflect reject coins instead of one of the controllable coin separating stations. In addition to this, the deflector 119 of the illustrated embodiment also serves a purpose for deflecting any valid coin, which has been positively identified by the coin sensor 112 and the controller 130 as a valid coin and thus should have been separated by any of the coin separating stations 113, 114 but in fact has not been separated and arrives at position c₁₁ after the last coin separating station 114. The reason for this may be a mismatch in timing of the control signals from the controller 130 to the coin separating stations 113, 114, so that the controllable member 115, 116 is activated a bit too late and the valid coin will “escape” the controllable member. Another situation is when the coin bag of the currently used coin separating station 113, 114 has become full and a switch is to be done to the coin bag of the other coin separating station 114, 113. When this happens, the coin input trapdoor 27 is preferably closed so as to prevent further coins c₁ from entering the coin processing device 100 until the switch to the new coin bag has been completed, but nevertheless there may still be coins C₂-C₈ in the coin processing device 100 that have not yet passed the coin separating stations 113, 114. Thus, these stations are kept inactive by the controller during the switch of coin bags, wherein such valid but non-separated coins will be deflected by the deflector 119 at c₁₁ into the reject receptacle 30.

The coin input trapdoor 27 is automatically closed by the controller 130 and the actuator 28, and the operation of the belt 25 is suspended, in the following situations:

When an error condition has been detected in the coin processing device 100, such as a coin jam.

When a calibration of the sensor 112 is to be performed. To allow optimum coin discriminating accuracy, certain parameters related to aforesaid coin reference data are regularly updated by obtaining “no-coin” or idle measurement values by the coin sensor 112 when no coin is present along the transport path. Thanks the provision of the deflector 119 in combination with the coin input trapdoor 27, a no-coin situation may be quickly reached also during an ongoing coin processing transaction. When the calibration is to be performed, the coin input trapdoor 27 is closed, and coins yet to be processed will remain in the coin input region 24, whereas existing coins within the coin processing device will be rapidly processed by the stations 113, 144 or deflector 119.

In addition to the above, the coin input trapdoor 27 is also kept closed at start-up of the apparatus so as to allow it to reach a correct operating temperature, etc.

The reject receptacle 30 is used in the illustrated embodiment also for a third category of coins, referred to as “fall-off” coins. Such a fall-off coin is illustrated at c_{fall-off} in FIG. 3. A fall-off coin is a coin that for some reason loses engagement with the resilient rim 111 prior to the intended destination (coin separating station 113, 114, deflector 119). One example why this may happen is shown in FIG. 3; two adjacent coins C₄ and c₅ do not leave enough space for the coin c_{fall-off} to engage with the resilient rim 111. Instead, this coin will be pushed out of contact with the resilient rim 111 by the knife 110 and coin C₄, C₅ into the channel 120 and reject receptacle 30.

The invention has been described above with reference to an exemplifying embodiment. However, as is readily appreciated by a person skilled in the art, other embodiments than the one disclosed above are equally possible within the scope of the invention as defined by the appended patent claims.

What is claimed is:

1. A coin handling apparatus comprising an apparatus housing and a coin processing device contained within said apparatus housing, wherein said apparatus housing has a coin intake, said coin handling apparatus being adapted to receive coins to be processed by said coin processing device through said coin intake from a user,
wherein said apparatus housing comprises a first housing part and a second housing part, said coin intake being provided in said second housing part; and
wherein said coin handling apparatus comprises means for supporting slidable displacement of said second housing part with respect to said first housing part so as to expose said coin processing device to said user.

2. An apparatus according to claim 1, wherein said second housing part has a top side surface, said coin intake being provided at said top side surface.

3. An apparatus according to claim 2, wherein said second housing part is displaceable from said first housing part in a substantially horizontal direction parallel to said top side surface.

4. An apparatus according to claim 1, further comprising a base onto which said coin processing device is mounted, wherein said base remains fixed with respect to said first housing part when said second housing part is displaced from said first housing part.

5. An apparatus according to claim 4, wherein said means for supporting slidable displacement includes a pair of rails mounted to said base.

6. An apparatus according to claim 1, further comprising a conveyor belt provided at said coin intake, said conveyor belt being adapted to receive said coins to be processed from said user and to feed said received coins to said coin processing device.

7. An apparatus according to claim 1, further comprising a coin input trapdoor provided at said coin intake, said trapdoor being controllable to assume first and second positions, wherein, in the first position, said received coins are prevented from entering said coin processing device and wherein, in the second position, said received coins are permitted to enter said coin processing device.

8. An apparatus according to claim 7, further comprising a controller, wherein said controller is adapted, in response to a detected malfunction of said apparatus in the form of an unexpected displacement of said second housing part from said first housing part during an ongoing coin processing transaction, to cause said trapdoor to assume its first position.

9. An apparatus according to claim 7, further comprising a controller and a coin sensor, the coin sensor being adapted to detect at least one physical characteristic in the presence of a coin, wherein said controller is adapted, during an ongoing coin processing transaction, to
cause said trapdoor to assume its first position so as to prevent input of coins from said coin intake to said coin processing device;
cause said coin sensor to produce a calibration value related to said at least one physical characteristic in the absence of coins; and
cause said trapdoor to assume its second position so as to admit input of coins from said coin intake to said coin processing device.

10. An apparatus according to claim 8 and having a conveyor belt provided at said coin intake, said conveyor belt being adapted to receive said coins to be processed from said user and to feed said received coins to said coin processing device, wherein said controller is adapted, when causing said trapdoor to assume its first position, to also cause said conveyor belt to stop feeding received coins.

11. An apparatus according to claim 9 and having a conveyor belt provided at said coin intake, said conveyor belt being adapted to receive said coins to be processed from said user and to feed said received coins to said coin processing device, wherein said controller is adapted, when causing said trapdoor to assume its first position, to also cause said conveyor belt to stop feeding received coins.

12. A coin handling apparatus according to claim 1, wherein said coin processing device comprises a plurality of coin separating stations and a coin sensor positioned along a circular transport path defining a coin transport direction, each coin separating station comprising a controllable member for separating coins individually off said circular transport path in response to at least one coin characteristic detected by said coin sensor, wherein said coin separating stations include at least one station assigned for separation of valid coins, as indicated by said at least one coin characteristic.

13. A coin handling apparatus having
an apparatus housing comprising a first housing part and a second housing part;
a coin intake in said apparatus housing; and
a coin processing device contained within said apparatus housing, said coin handling apparatus being adapted to receive coins to be processed by said coin processing device through said coin intake from a user,
wherein said coin intake is provided in said second housing part, and
wherein said second housing part is slidably displaceable from said first housing part so as to expose said coin processing device to said user.
